(19) United States
(12) Patent Application Publication
(10) Pub. No.: US 2026/0061646 A1
(43) Pub. Date: Mar. 5, 2026

(54) ELECTRIC HAIR CUTTING DEVICE WITH BLADE ADJUSTMENT MECHANISM

(71) Applicant: WAHL CLIPPER CORPORATION, Sterling, IL (US)

(72) Inventor: Gary M. ERICKSON, Lena, IL (US)

(21) Appl. No.: 19/311,375

(22) Filed: Aug. 27, 2025

Related U.S. Application Data
(60) Provisional application No. 63/689,047, filed on Aug. 30, 2024.

(51) Int. Cl. B26B 19/20; B26B 19/04

(52) U.S. Cl. CPC B26B 19/205; B26B 19/046

(57) ABSTRACT

An electric hair cutting device with a blade adjustment mechanism includes a housing. A bladeset is attached to the housing that includes a moving blade and a stationary blade. A blade slide is externally mounted to the housing and mounted to the stationary blade. The blade slide and stationary blade are slidable relative to the moving blade. The electric hair cutting device also includes a taper lever mechanism. The taper lever mechanism allows for adjusting a position of the blade slide and stationary blade relative to the housing. The taper lever defines a rotational axis. The taper lever mechanism has a selectively positionable collar with a first setting and a second setting. In the first setting, rotation of the taper lever about a rotational axis of the taper lever mechanism produces an audible response. In the second setting, rotation of the taper lever does not produce an audible response.

### RELATED APPLICATION

The present application claims the benefit under 35 U.S.C. 119(e) of US Provisional Application No. 63/689,047 filed Aug. 30, 2024, the entire contents of which are incorporated by reference herein.

### BACKGROUND

The present invention relates generally to electric hair cutting devices such as hair clippers and hair trimmers, and more specifically to blade adjustment mechanisms thereof.

Electric hair cutting devices include a moving blade that laterally reciprocates in relation to a stationary blade to perform a cutting action. Both the moving blade and the stationary blade have teeth, and both blades are collectively referred to as the clipper bladeset. Hair caught between the teeth of the blades is sheared through movement of the moving blade relative to the stationary blade.

Contemporary electric hair cutting devices also include an electric motor that is powered by an on-board battery, and/or via a supply voltage from an outlet. The motor is mechanically coupled to the moving blade to produce the reciprocation of the moving blade via one of a variety of different mechanical linkage formats (e.g. eccentric cam arrangements, pivot arm arrangements, etc.).

Additional features may also be included, such as cutting length adjustment mechanisms used to finely control the length of hair cut by the device. One such cutting length adjustment mechanism in general involves moving the stationary blade relative to the moving blade using what is known in the art as a taper lever mechanism. The stationary blade teeth have an increasing thickness moving from the tips thereof toward the base thereof. Hair must extend at least as far as this thickness before reaching the interface of the teeth of the moving blade and the teeth of the stationary blade where it is cut. These taper lever mechanisms allow the user to set where, along the thickness of the stationary blade, the interface between the teeth of the moving blade and the teeth of the stationary blade resides, and hence determine where along the variable thickness of the stationary blade hair must pass through before being cut. Such a configuration allows for fine adjustment of hair cut length.

Many conventional hair clippers are equipped with such taper lever mechanisms that operate using a smooth or infinite number of adjustments, while other designs offer a series of preset adjustment positions. The latter may offer a tactile feedback to the operator of indexed lever movement. Some designs have been envisioned which allow the user to select whether the taper lever operates smoothly or instead has preset adjustment positions with tactile feedback. However, these designs typically require significant effort to make this selection. Further, these designs may add undue complexity and possible failure modes. Still further, these designs are typically created from the ground up, and cannot be readily employed in existing devices in the field.

Accordingly, there is a need for an improved electric hair cutting device which utilizes a taper lever adjustment mechanism that may be readily and easily changed from a smooth operation design to a design which employs preset adjustment positions without adding undue complexity to the overall system. Further, there is a need in the art for a taper lever mechanism offering both options of smooth operation and preset positions that can be incorporated into existing devices in the field.

### SUMMARY

In one aspect, an electric hair cutting device as described herein advantageously provides a taper lever mechanism that provides a selectable audible and tactile feedback feature upon manipulation of a taper lever thereof. Such an arrangement also provides a taper lever with an optional setting providing predefined orientations which define different hair cut lengths. An embodiment of such an electric hair cutting device includes a housing having a first end and a second end. A bladeset is attached to the first end. The bladeset includes a moving blade and a stationary blade.

A blade slide is externally mounted to the first end of the housing and mounted to the stationary blade. The blade slide and stationary blade are slidable relative to the moving blade. The electric hair cutting device also includes a taper lever mechanism. The taper lever mechanism defines a rotational axis and includes a taper lever that allows for adjusting a position of the blade slide and stationary blade relative to the first end of the housing. The taper lever mechanism has a selectively positionable collar with a first setting and a second setting. In the first setting, rotation of the taper lever about a rotational axis of the taper lever mechanism produces an audible response. In the second setting, rotation of the taper lever does not produce an audible response.

The taper lever mechanism of this embodiment also includes a cam ring mounted to the taper lever, a bushing mounted to the housing, a washer, a biasing element acting between the collar and the washer, and a fastener for mounting the taper lever, cam ring, bushing, biasing element, and washer to the housing. The bushing has a body with a first end and a second end and a central bore centered on the rotational axis. The collar has a body with a first end, a second end, and a central bore centered on the rotational axis.

The collar of this embodiment includes a shelf extending radially inward from the body within the central bore of the collar. The shelf of the collar includes a geared portion having a plurality of gear teeth arranged to selectively mesh with a plurality of gear teeth formed on the bushing. The plurality of the gear teeth of the collar and the plurality of gear teeth of the bushing are in meshed contact in the first setting. The plurality of gear teeth of the collar and the plurality of gear teeth of the bushing are not meshed in the second setting.

In another aspect, a taper lever mechanism is provided which can be readily installed onto an electric hair cutting device with an external blade slide, allowing the user to introduce audible and tactile feedback with operation of the taper lever into an existing device in their tool kit. An embodiment of such a taper lever mechanism includes a taper lever defining a rotational axis, a cam ring having a central bore centered on the rotational axis, a bushing having a body with a first end, second end, and a central bore centered on the rotational axis, and a collar having a body with a first end and a second end, and a central bore centered on rotational axis. A biasing element is situated within the central bore of the collar.

The cam ring of this embodiment includes a first side, second side, and an annular wall axially projecting from the first side. The annular wall includes a first keying feature mating with a keying feature of the taper lever such that the cam ring rotates about the rotational axis with the taper lever. The cam ring includes a cam lobe extending from the second side of the cam ring.

The bushing of this embodiment includes a shelf extending radially outward from the body and interposed between the first end and second end of the body of the bushing. The shelf includes a first side and a second side, wherein a plurality of gear teeth are formed on the first side. The plurality of gear teeth of the shelf do not circumscribe the body of the bushing. The second end of the bushing includes a keying feature mating with a keying feature formed on the housing such that the bushing cannot rotate about the rotational axis.

The second end of the collar of this embodiment includes a keying feature mating with a second keying feature of the cam ring. The collar includes a shelf extending radially inward from the body of the collar and within the central bore of the collar. The shelf of the collar includes a first side and a second side. A plurality of gear teeth are formed on the second side of the shelf of the collar.

The collar is selectively positionable between a first setting and a second setting. In the first setting the plurality of gear teeth are in meshed contact with a plurality of gear teeth of the bushing. In the second setting the plurality of gear teeth are not in meshed contact with the plurality of gear teeth of the bushing. In the first setting, the collar has a first rotational position relative to the taper lever, and in the second setting, the collar has a second rotational position relative to the taper lever different than the first rotational position.

Other aspects, objectives, and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of an electric hair cutting device constructed in accordance with the teachings herein;

FIG. 2 is another perspective view of the electric hair cutting device of FIG. 1, with a taper lever mechanism thereof shown in an exploded view;

FIG. 3 is a perspective view of a taper lever of the taper lever mechanism of FIG. 2;

FIG. 4 is a perspective view of a collar of the taper lever mechanism of FIG. 2;

FIG. 5 is another perspective view of the collar of FIG. 4;

FIG. 6 is a perspective view of a cam ring of the taper lever mechanism of FIG. 2;

FIG. 7 is another perspective view of the cam ring of FIG. 6;

FIG. 8 is a perspective view of a bushing of the taper lever mechanism of FIG. 2;

FIG. 9 is another perspective view of the bushing of FIG. 8;

FIG. 10 is a partial cross sectional perspective view of the taper lever mechanism of FIG. 2 shown in a first operational state;

FIG. 11 is a partial cross sectional perspective view of the taper lever mechanism of FIG. 2 shown in a second operational state; and

FIG. 12 is a side view of the taper lever mechanism of FIG. 2.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

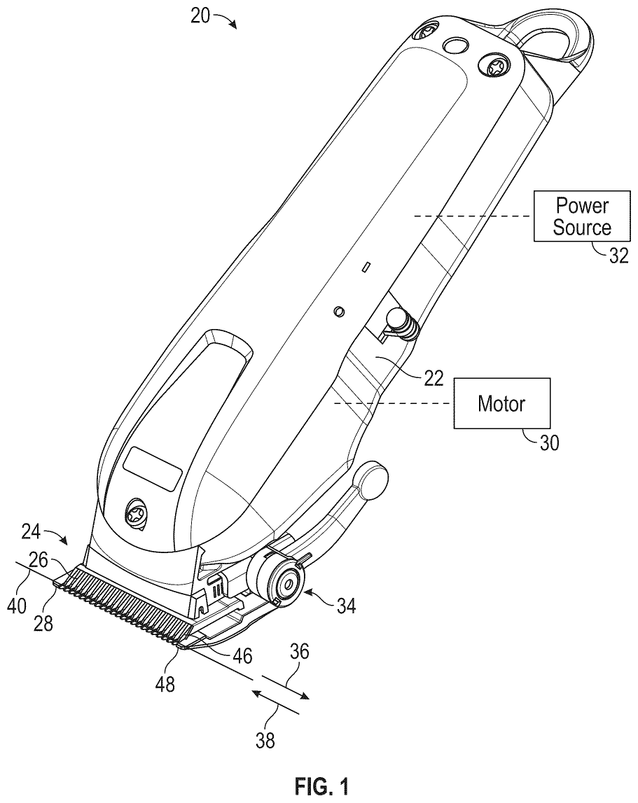

Turning now to the drawings, FIG. 1 illustrates an exemplary embodiment of an electric hair cutting device embodied herein for non-limiting example as a hair clipper 20. Hair clipper 20 includes a housing 22 having a first end and a second end. A bladeset 24 is mounted at the first end. Bladeset 24 includes a moving blade 26 which moves relative to a stationary blade 28 to produce a hair cutting action. While the following description will be provided in the context of a hair clipper of the type shown in FIG. 1, the invention is not limited to the device illustrated, and it is envisioned that the teachings herein may be readily applied to other devices such as hair trimmers, or any electric hair cutting device having a reciprocating blade.

Hair clipper 20 includes an internal electric motor 30 powered via a power source 32. It will be recognized from the description herein that the invention is not constrained to a particular power source or a particular motor type. For example, power source 32 may be embodied by an internal battery carried by housing 22 or may be an external power source such as a supply voltage provided by a wall outlet.

A mechanical linkage (not shown) connects motor 30 to bladeset 24 to induce a reciprocating motion to moving blade 26 relative to stationary blade 28 to provide a cutting action. More specifically, moving blade 26 is operable to reciprocate in first and second directions 36, 38 along a cutting axis 40. Cutting axis 40 is defined generally at the line defined by the tips of a plurality of moving teeth 46 of moving blade 26 as located relative to a plurality of stationary teeth 48 of stationary blade 28.

Hair clipper 20 also includes an adjustment mechanism 34 for adjusting a relative distance between the tips of the teeth of moving blade 26 and the tips of the teeth of stationary blade 28. In the illustrated embodiment, adjustment mechanism 34 moves stationary blade 28 relative to moving blade 26.

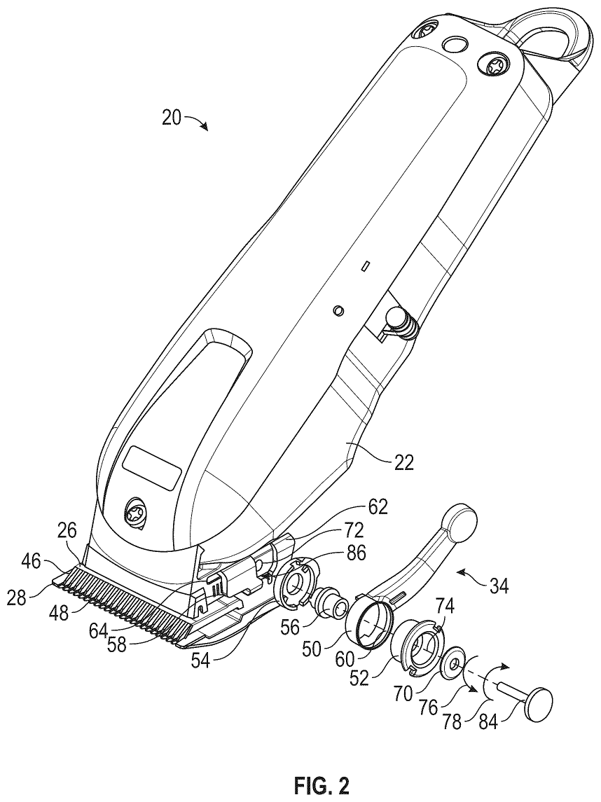

Turning now to FIG. 2, the componentry of adjustment mechanism 34 is shown in an exploded view. Adjustment mechanism 34 includes a rotatable taper lever 50, a collar 52, a cam ring 54, and a bushing 56. As will be explained below, taper lever 50, collar 52 and cam ring 54 are connected in such a way that rotation of taper lever 50 produces a like rotation of collar 52 and cam ring 54. These components rotate relative to bushing 56. Collar 52 has multiple settings based on its angular orientation relative to bushing 56. In a first setting of collar 52, rotation of taper 50 provides an audible and tactile feedback to the user indicating step-wise discrete positions of taper lever 50. In a second setting of collar 52, no audible or tactile feedback is provided to the user when rotating taper lever 50.

Taper lever 50 acts upon a blade slide 58. More specifically, rotation of taper lever 50 about a longitudinal axis 74 of adjustment mechanism 34 in rotational directions 76, 78 produces a corresponding linear movement of blade slide 58. Stationary blade 28 is fixed to blade slide 58 such that stationary blade 28 linearly moves with blade slide 58. This allows a user to position the tips of moving teeth 46 farther away from the tips of stationary teeth 48 when taper lever 50 is rotated in rotational direction 76, and position moving teeth 46 closer to the tips of stationary teeth 48 when taper lever 50 is rotated in rotational direction 78. While directions 76 and 78 are indicated respectively as counter-clockwise and clockwise, it is contemplated that the directions are optionally reversed to suit the application.

Blade slide 58 is slidably mounted to housing 22 via one or more tab portions 62 received within rails 64 of housing 22 as is typical with externally mounted blade slides in the art. However, one advantage of the instant invention is the capability to install adjustment mechanism 34 onto units with an externally mounted blade slide as is shown in FIG. 2. This allows users to upgrade their existing units with so-called “click-no-click” functionality, i.e. the ability to implement an adjustment mechanism that optionally provides tactile feedback and discrete positions of the taper lever thereof.

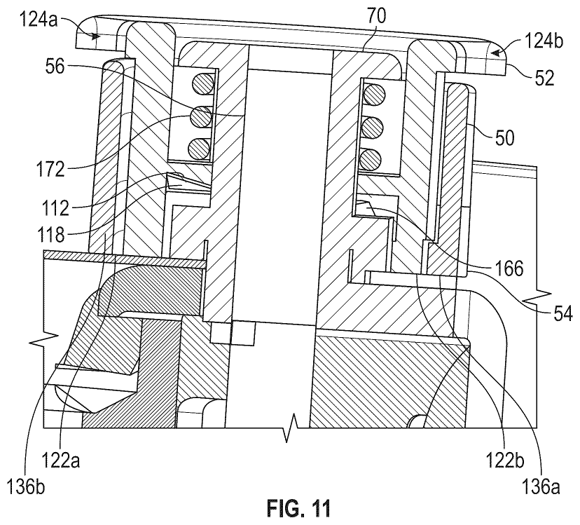

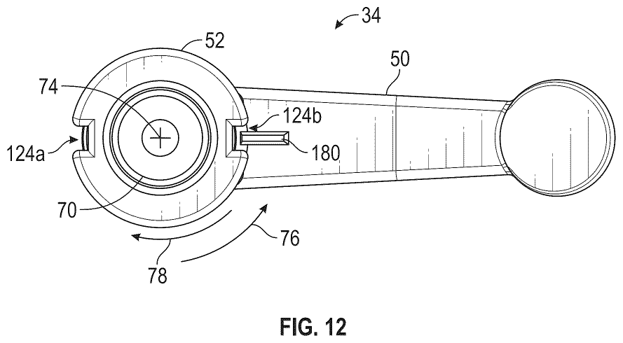

Taper lever 50, collar 52, cam ring 54, and bushing 56 are coaxially mounted along longitudinal axis 74. A fastener 84 and an optional washer 70 may also be provided to rotationally mount the componentry of adjustment mechanism 34 to housing 22. As may be seen in FIG. 2, housing 22 includes an aperture 72 for receipt of an end of fastener 84. As described in greater detail below relative to FIGS. 11 and 12, a spring 172 is also provided between washer 70 and collar 52 to bias collar 52 towards bushing 56.

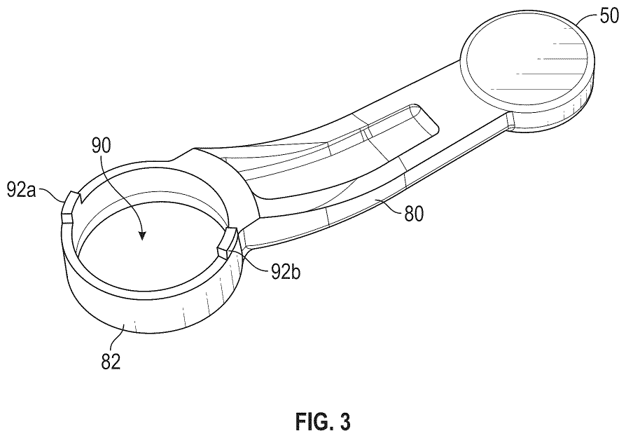

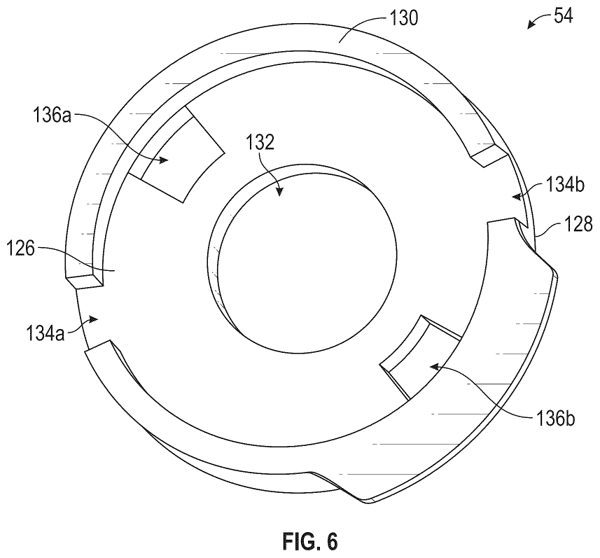

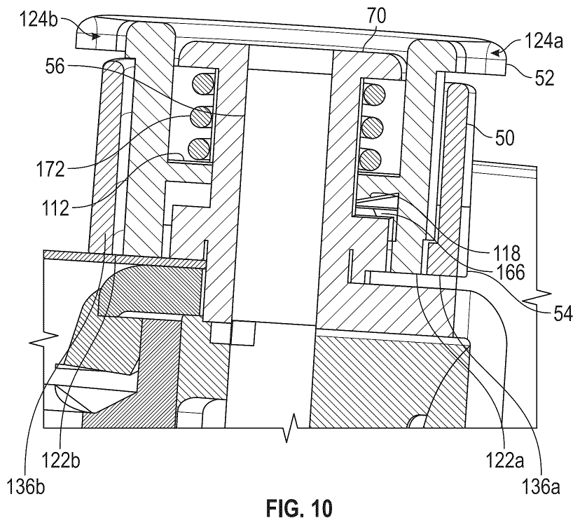

With reference to FIG. 3, taper lever 50 includes a handle portion 80 and a ring portion 82 as shown. Ring portion 82 includes a keying feature in the form of a pair of tabs 92a, 92b which is received by a first keying feature in the form of a pair of notches 134a, 134b of cam ring 54 (see FIG. 6), respectively. Ring portion 82 defines a central bore 90 within which collar 52 and bushing 56 extend (see e.g. FIGS. 10 and 11). While shown as a pair of tabs 92a, 92b and a pair of corresponding notches 134a, 134b, the term “keying feature” as used herein relative to any component means any feature capable of mating two components such that they are rotationally fixed relative to one another.

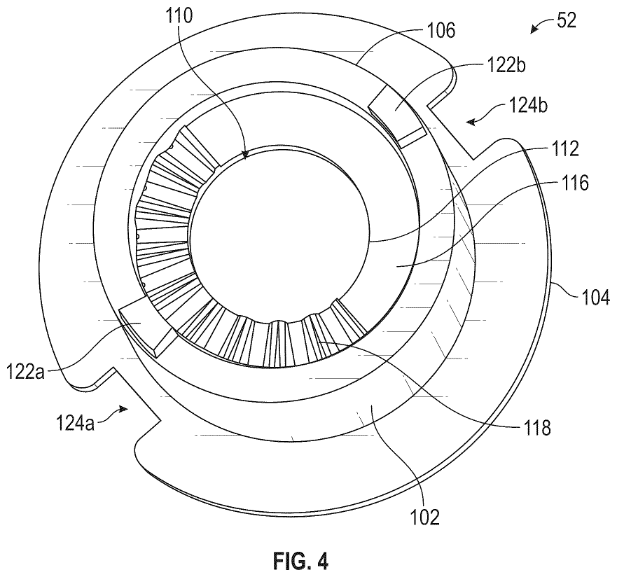

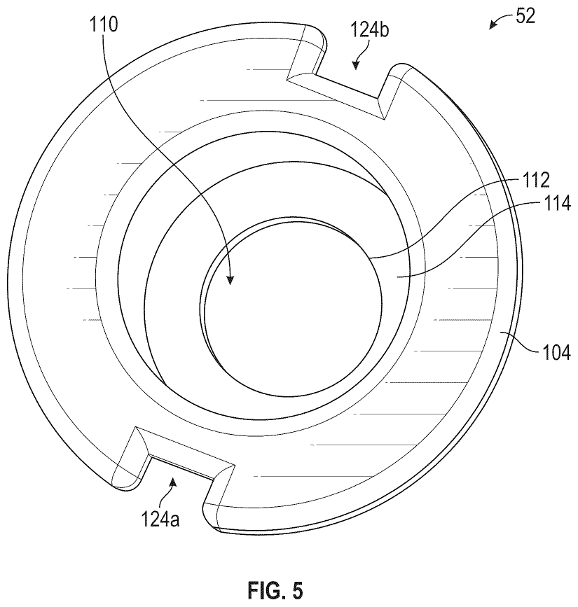

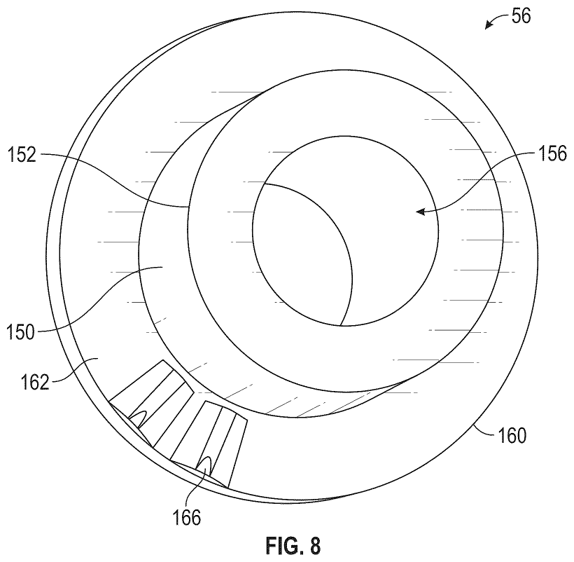

Turning to FIG. 4, collar 52 has a generally cylindrical body 102 having a first end 104 and a second end 106. Body 102 includes a bore 110. A shelf 112 having a first side 114 (see FIG. 5) and a second side 116 extends radially inward from body 102 as shown. A plurality of gear teeth 118 are formed partially along the circumference of shelf 112. Gear teeth 118 are arranged to selectively mesh with a plurality of gear teeth 166 formed on bushing 56 (see FIG. 8). More specifically, collar 52 has a first setting wherein gear teeth 118 are in meshed contact with gear teeth 166, and a second setting wherein gear teeth 118 are not in meshed contact with gear teeth 166. To change between the first and second settings, a user can pull collar 52 along longitudinal axis 74 (see FIG. 2) away from housing 22, rotate collar 52 one hundred and eighty degrees about longitudinal axis 74, then then allow collar 52 to return along longitudinal axis 74, as described in greater detail relative to FIGS. 10-12.

Additionally, second end 106 includes a keying feature in the form of a pair of tabs 122a, 122b received in a second keying feature in the form of a pair of openings 136a, 136b, respectively, of cam ring 54 (see FIG. 6). Referring momentarily to FIG. 2, because taper lever 50 is keyed relative to cam ring 54, and because collar 52 is keyed to cam ring 54, any rotation of taper lever 50 about longitudinal axis 74 in directions 76, 78 results in a like rotation of collar 52 and cam ring 54. Collar 52 also includes an indicator feature in the form of one or more notches 124a, 124b generally at first end 104 of collar 52. As will be explained below, notches 124a, 124b are selectively alignable with an indicator feature in the form of a raised portion 180 (see FIG. 12) formed on taper lever 50 to indicate whether adjustment mechanism 34 is in the first setting of the second setting. As used herein, “indicator feature” refers to any structure capable of indicating a position of one component relative to another.

As may be inferred from FIG. 5, bore 110 is large enough in diameter to permit passage of bushing 56 (see also FIGS. 10 and 11). Washer 70 (see FIG. 2) seats upon an end of bushing 56, and is described below, and fastener 84 (see FIG. 2) seats upon washer 70. As may also be seen in FIG. 5, first side 114 of shelf 112 defines a generally flat annular surface.

With reference to FIG. 6, cam ring 54 includes a first side 126 and a second side 128. An annular ring or wall 130 extends axially from first side 126. The previously introduced pair of notches 134a, 134b are formed in annular wall 130. A bore 132 is centrally formed through cam ring 54 to permit passage of an end of fastener 84 (see FIG. 2).

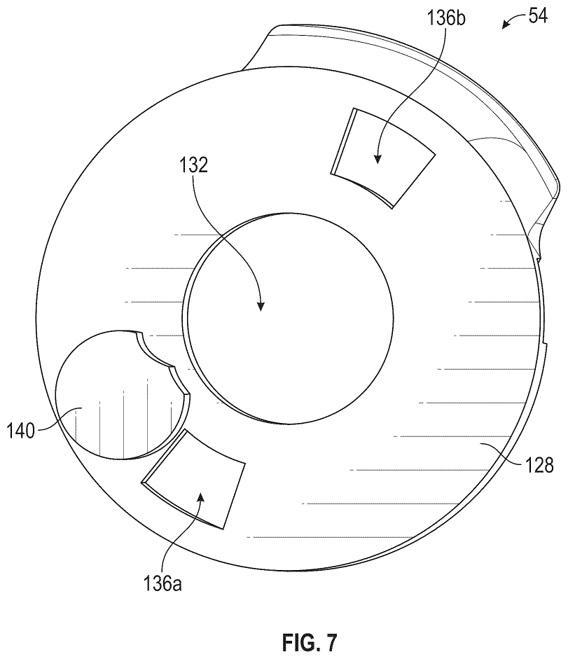

As shown in FIG. 7, a cam lobe 140 extends from second side 128 of cam ring 54. Cam lobe 140 is off center from the circumferential center of cam ring 54. Cam lobe 140 is received within a slot 86 formed on blade slide 58 (see FIG. 2). This off-center relationship produces a linear movement of blade slide 58 when taper lever 50 is rotated.

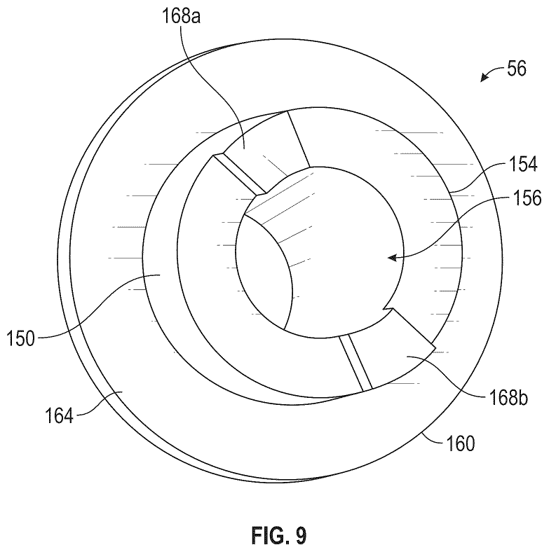

Turning now to FIGS. 8 and 9, bushing 56 includes a body 150 having a first end 152 and a second end 154, and a central bore 156 for allowing passage of fastener 84 (see FIG. 2). A shelf or flange 160 extends radially outward from body 150. Shelf 160 includes a first side 162 and a second side 164 (see FIG. 9). The previously introduced gear teeth 166 are formed on the first side 162. It should be noted that bushing 56 remains rotationally fixed relative to collar 52 when collar 52 rotates with taper lever 50 (see e.g. FIG. 2). As a result, when gear teeth 118 of collar 52 (see FIG. 4) move along gear teeth 166 of bushing 56, an audible clicking noise is perceptible and a tactile sensation is felt at the taper lever 50. This meshing also defines discrete positions of the taper lever 50 through its range of travel.

With reference to FIG. 9, the second end 154 of bushing 56 includes a keying feature in the form of one or more tabs 168a, 168b as shown. Tabs 168a, 168b are received in corresponding formations (not shown) of housing 22 (see FIG. 2). This arrangement prevents rotation of bushing 56 about longitudinal axis 74 (see FIG. 2).

FIGS. 10 and 11 illustrate collar 52 in the above introduced first and second settings, respectively. Turning first to FIG. 10, collar 52 is rotationally positioned such that gear teeth 118 and 166 are in meshed contact. A biasing element in the form of a spring 172 acts between washer 70 (held in place by fastener 84) and shelf 112 to bias collar 52 into contact with bushing 56, and more particularly gear teeth 118 into meshed contact with gear teeth 166. When in this first setting, rotation of collar 52 with taper lever 50 causes the teeth 118, 166 to move relative to one another and thereby produce an audible clicking sound and tactile sensation at taper lever 50.

Turning now to FIG. 11, collar 52 has been repositioned into the second setting. In this setting teeth 118 (see FIG. 10) do not mesh with teeth 166 throughout the rotational range of motion of collar 52 and taper lever 50. As a result, rotation of taper lever 50 does not produce any audible clicking sound, nor is there any tactile sensation at taper lever 50. Fastener 84 has been removed from FIGS. 10 and 11 for purposes of illustration clarity.

With reference to FIG. 12, to transition adjustment mechanism 34 to the first setting (see also FIG. 10), collar 52 is pulled axially along axis 74 away from housing 22 (see FIG. 2) against the biasing force of spring 172 (see FIG. 10) and rotated 180 degrees about axis 74 in rotational direction 76 to align notch 126b with raised portion 180. To move from the first setting to the second setting as is shown in FIG. 11, collar 52 is pulled away from housing 22 along axis 74, rotated 180 degrees about axis 74 in direction 78 to align notch 124a with raised portion 180. Thereafter, collar 52 may be released and biased back toward housing 122 by spring 172.

A key advantage of the embodiment described herein is the ability to selectively set adjustment mechanism 34 to a setting wherein sound and tactile feedback are provided and to another setting wherein no sound and tactile feedback are provided. Some users prefer one configuration over the other, so greater flexibility is achieved. Further, because adjustment mechanism 34 is configured to operate with an externally mounted blade slide 58, it may be readily retrofit on units that do not otherwise offer any audible or tactile feedback with minimal or no modification to the device.

All references, including publications, patent applications, and patents cited herein are hereby incorporated by reference to the same extent as if each reference were individually and specifically indicated to be incorporated by reference and were set forth in its entirety herein.

The term “electric hair cutting device” as used herein includes any electric hair cutting device that includes a motor which drives a moving blade to cut hair, including but not limited to hair clippers, hair trimmers, and electric shavers, for human or for animal application. The terms “hair clipper” and “hair trimmer” are used interchangeably unless otherwise noted, and do not limit the scope or applicability of the invention herein to either particular variant.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electric hair cutting device, comprising:
a housing having a first end and a second end;
a bladeset attached to the first end, the bladeset including a moving blade and a stationary blade;
a blade slide externally mounted to the first end of the housing and mounted to the stationary blade, the blade slide and stationary blade slidable relative to the moving blade;
a taper lever mechanism defining a rotational axis and including a taper lever for adjusting a position of the blade slide and stationary blade relative to the first end of the housing, the taper lever mechanism having a selectively positionable collar with a first setting and a second setting, wherein in the first setting rotation of the taper lever about a rotational axis of the taper lever mechanism produces an audible response, and wherein in the second setting, rotation of the taper lever does not produce an audible response.

2. The electric hair cutting device of claim 1, wherein the taper lever mechanism further comprises a cam ring mounted to the taper lever, a bushing mounted to the housing, a washer, a biasing element acting between the collar and the washer, and a fastener for mounting the taper lever, cam ring, bushing, biasing element, and washer to the housing.

3. The electric hair cutting device of claim 2, wherein the bushing has a body with a first end and a second end and a central bore centered on the rotational axis.

4. The electric hair cutting device of claim 3, wherein the collar has a body with a first end, a second end, and a central bore centered on the rotational axis.

5. The electric hair cutting device of claim 4, wherein the collar includes a shelf extending radially inward from the body within the central bore of the collar.

6. The electric hair cutting device of claim 5, wherein the shelf of the collar includes a geared portion having a plurality of gear teeth arranged to selectively mesh with a plurality of gear teeth formed on the bushing.

7. The electric hair cutting device of claim 6, wherein the plurality of the gear teeth of the collar and the plurality of gear teeth of the bushing are in meshed contact in the first setting, and wherein the plurality of gear teeth of the collar and the plurality of gear teeth of the bushing are not meshed in the second setting.

8. A taper lever mechanism for an electric hair cutting device, the electric hair cutting device comprising a housing, a first end and a second end, a bladeset attached to the first end, the bladeset including a moving blade and a stationary blade, a blade slide externally mounted to the first end of the housing and mounted to the stationary blade, the blade slide and stationary blade slidable relative to the moving blade, the taper lever mechanism comprising:
a taper lever defining a rotational axis;
a cam ring having a central bore centered on the rotational axis;
a bushing having a body with a first end, second end, and a central bore centered on a rotational axis;
a collar having a body with a first end and second end, and a central bore centered on a rotational axis; and
a biasing element situated within the central bore of the collar.

9. The taper lever mechanism of claim 8, wherein the cam ring includes a first side, second side, and an annular wall axially projecting from the first side.

10. The taper lever mechanism of claim 9, wherein the annular wall includes a first keying feature mating with a keying feature of the taper lever such that the cam ring rotates about the rotational axis with the taper lever.

11. The taper lever mechanism of claim 9, wherein the cam ring includes a cam lobe extending from the second side of the cam ring.

12. The taper lever mechanism of claim 8, wherein the bushing includes a shelf extending radially outward from the body and interposed between the first end and second end of the bushing.

13. The taper lever mechanism of claim 12, wherein the shelf includes a first side and a second side, wherein a plurality of gear teeth are formed on the first side.

14. The taper lever mechanism of claim 13, wherein the plurality of gear teeth of the shelf do not circumscribe the body of the bushing.

15. The taper lever mechanism of claim 8, wherein the second end of the bushing includes a keying feature mating with a keying feature formed on the housing such that the bushing cannot rotate about the rotational axis.

16. The taper lever mechanism of claim 8, wherein the second end of the collar includes a keying feature mating with a second keying feature of the cam ring.

17. The taper lever mechanism of claim 8, wherein the collar includes a shelf extending radially inward from the body of the collar and within the central bore of the collar.

18. The taper lever mechanism of claim 17, wherein the shelf of the collar includes a first side and a second side, wherein a plurality of gear teeth are formed on the second side of the shelf of the collar.

19. The taper lever mechanism of claim 18, wherein the collar is selectively positionable between a first setting and a second setting, wherein in the first setting the plurality of gear teeth are in meshed contact with a plurality of gear teeth of the bushing, and wherein in the second setting the plurality of gear teeth are not in meshed contact with the plurality of gear teeth of the bushing.

20. The taper lever mechanism of claim 19, wherein in the first setting, the collar has a first rotational position relative to the taper lever, and in the second setting, the collar has a second rotational position relative to the taper lever different than the first rotational position.
